(19) United States
(12) Patent Application Publication
(10) Pub. No.: US 2022/0240496 A1
(43) Pub. Date: Aug. 4, 2022

(54) CABLE-FREE TREE STAND WITH REMOVABLE PLATFORM

(71) Applicant: Christopher A. Miller, Baltic, OH (US)

(72) Inventor: Christopher A. Miller, Baltic, OH (US)

(21) Appl. No.: 17/161,735

(22) Filed: Jan. 29, 2021

(51) Int. Cl. A01M 31/02

(52) U.S. Cl. CPC A01M 31/02

(57) ABSTRACT

A hang-on tree stand having a frame and an assembly pivotally connected to and supported by the frame, the frame being free of cables. The assembly has a platform removably connected to the assembly.

### BACKGROUND OF THE INVENTION

### Field of the Invention

The invention relates generally to hunting equipment. In particular, the invention relates to equipment used to aid a user in avoiding detection and increasing visual range while hunting. More particularly, the invention relates to a relatively light-weight hang-on tree stand with a removable platform that is free of cables, which is easy to install, eliminates tripping and snagging hazards, and maximizes usable space on the platform, while reducing impediments to the line of sight of the user, thereby improving visual range.

### Background Art

Hunting is a well-known outdoor sport. Success in hunting typically requires stealth and visual range to avoid detection and allow for sufficient time to prepare, aim, and fire a weapon. As a result, various devices have been developed that hide or provide obscurity from detection while also increasing visual range. In particular, tree stands have been developed to obscure bodies or objects, noise, and/or scents and enable relatively greater visual range. Tree stands are typically mounted on or secured to a trunk of a tree at a relatively substantial elevation from the ground. The elevation enables tree stands to be obscured from or outside of the visual plane of quarry. In addition, the elevation provides a user of the tree stand with an increased visual range, allowing quarry to be more easily spotted.

A known type of tree stand is generally referred to as a fixed or hang-on tree stand. Prior art hang-on tree stands must typically be carried by the user up the tree by climbing or using suitable means, such as a ladder or foot pegs, thus raising the tree stand to a desired elevation in order to install it. Prior art hang-on tree stands are typically built to withstand strains, stresses, or forces, generally referred to herein as forces, that the tree stand may experience during installation and use, such as the weight of an individual and/or other hunting equipment, and the recoil of weapons when discharged. In order to withstand such forces, prior art hang-on tree stands are typically made from relatively strong and heavy materials, such as steel. However, forming prior art hang-on tree stands entirely from such materials increases the weight of the tree stands and difficulty of carriage to and installation at the desired elevation.

In order to mitigate the weight of the materials used to form prior art hang-on tree stands, the tree stands typically have certain structural components replaced with cables. In particular, prior art hang-on tree stands generally include an upright frame and a pivotally-attached orthogonally-extending platform. More particularly, one or more cables extend between and are operatively connected to an upper portion of the frame and a suitable location on the platform. Typically, the cables extend from a central location or upper corners of the frame to respective distant corners of the platform. The cables are generally lighter weight and less cumbersome than the robust materials of the frame and platform, but have sufficient tensile strength to react forces acting on the platform. When the platform is pivoted to extend in parallel with the upright frame, the cables are generally slack, allowing the frame to be collapsed to a minimal profile or dimension. When the platform is pivoted to extend orthogonally away from the frame, the cables are placed in tension, providing the platform with support and bracing.

Prior hang-on tree stands, while satisfactory for their intended purpose, have disadvantages, drawbacks, and limitations. For example, the cables of prior art hang-on tree stands restrict lateral movement and rotation of the user. More specifically, the cables extend between the upright frame and the platform, creating boundaries or impediments to either side of the user, thereby limiting lateral movement of the user and restricting rotation of the user within a certain arc. As a result, prior art hang-on tree stands potentially obstruct or limit vision and/or aiming, potentially reducing the chances of hunting success. Moreover, the cables of prior art hang-on tree stands potentially act as impediments on which the user of the tree stand may trip, snag, or become entangled, potentially causing injury. Thus, there is a need in the art for a hang-on tree stand that is lightweight, robust, and free of cables.

The hang-on tree stand with removable platform of the present invention satisfies this need and overcomes the disadvantages, drawbacks, and limitations of the prior art. The hang-on tree stand of the present invention provides a light-weight tree-stand that is relatively easy to carry and install in a tree. The hang-on tree stand of the present invention eliminates support cables, reducing the likelihood of tripping, snagging, and entangling and the user while reducing limitations to lateral movement and rotation of the user, increasing the usable area on the platform, and reducing impediments to the user's line of sight, thereby improving visual range of the user.

### SUMMARY OF THE INVENTION

Objectives of the present invention include providing a hang-on tree stand that is light-weight and relatively easy to carry and install in a tree.

A further objective of the present invention is to provide a hang-on tree stand that reduces or eliminates tripping, snagging, and entangling hazards.

Yet another objective of the present invention is to provide a hang-on tree stand that reduces limitations to lateral movement and rotation, increases usable platform area, and reduces impediments to a user's line of sight to improve visual range of the user.

These objectives and advantages are obtained by the hang-on tree stand, according to the present invention, having a frame and an assembly pivotally connected to and supported by the frame, the frame being free of cables. The assembly has a platform removably connected to the assembly.

### BRIEF DESCRIPTION OF THE SEVERAL VIEWS OF THE DRAWINGS

The preferred embodiment of the present invention, illustrative of the best mode in which Applicant has contemplated applying the principles, is set forth in the following description, shown in the drawings, and particularly and distinctly pointed out and set forth in the appended claims.

FIG. 1 is a fragmentary bottom perspective view of an exemplary embodiment hang-on tree stand, according to the present invention, showing the tree stand with the platform removably connected thereto;

FIG. 2 is a perspective view of the hang-on tree stand shown in FIG. 1, showing the tree stand with the platform removed and with the support arms in the upright position;

FIG. 3 is a fragmentary lateral perspective view of the hang-on tree stand shown in FIGS. 1-2, showing the tree stand with the platform removed and with the support arms in the extended position;

FIG. 4 is an enlarged fragmentary perspective view of the hang-on tree stand shown in FIGS. 1-3, showing the support arms in the upright position; and

FIG. 5 is a perspective view of the hang-on tree stand platform shown in FIG. 1, showing the platform removed from the tree stand.

Similar reference characters identify similar parts throughout.

### DESCRIPTION OF THE PREFERRED EMBODIMENT

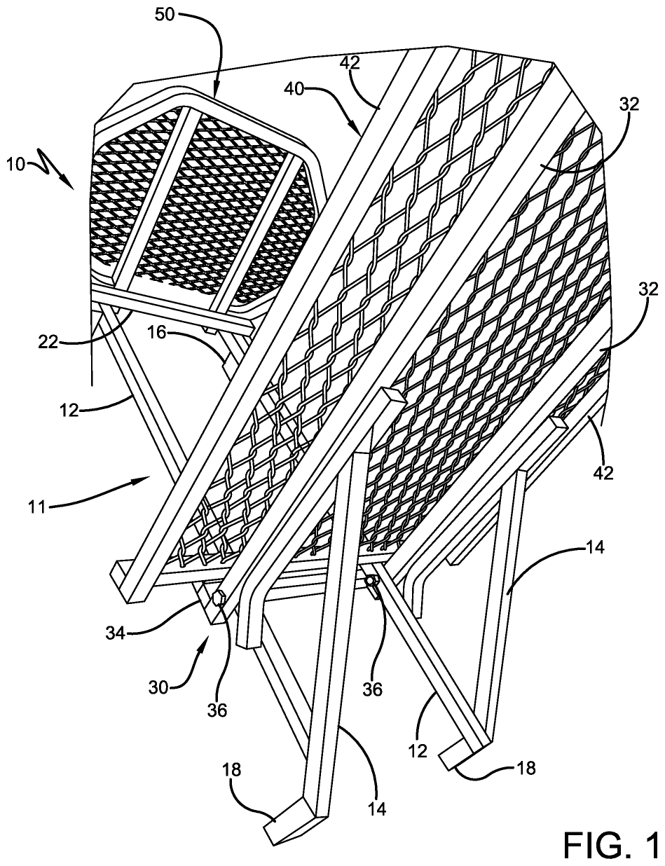

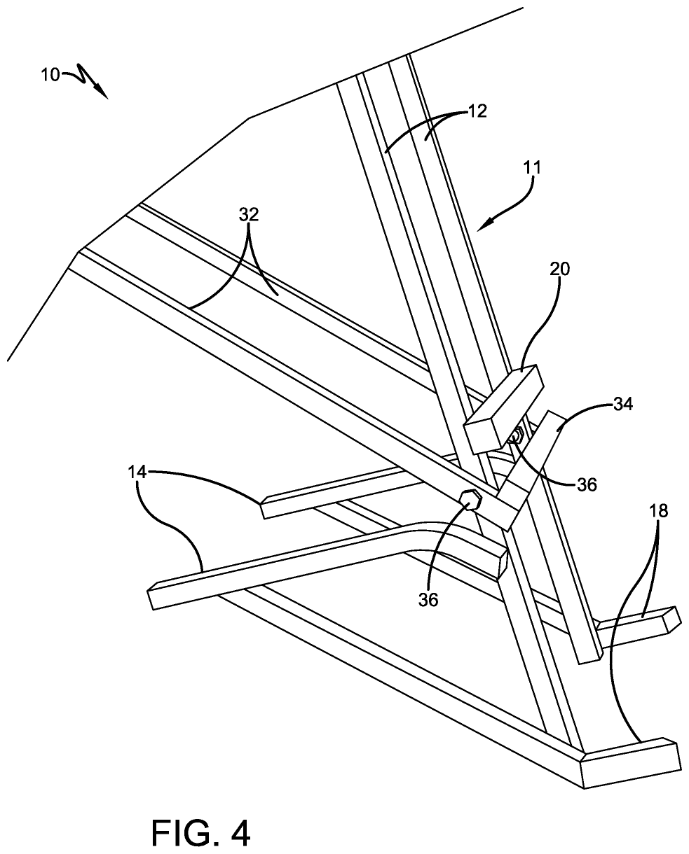

A hang-on tree stand 10 (FIGS. 1-5), according to the present invention, for installation on a trunk (not shown) of a tree (not shown) includes a frame 11 formed from any suitable material, such as box section steel, capable of withstanding the forces acting on the tree stand during use.

Frame 11 includes a pair of uprights 12, a cross-brace 20, a cross-member or hanger 22, and a pair of gussets 14. Uprights 12 are spaced apart from one another and include upper and lower portions and arranged to extend vertically when installed on the trunk of the tree. Uprights 12 may each include an upper extension or projection 16. Projections 16 may be integrally formed with uprights 12 or may be formed separately and fixedly connected to the uprights using any suitable means, such as welds. Upper projections 16 each extend from the upper portion of a respective upright 12 and orthogonally away from the plane of the uprights. Cross-brace 20 is perpendicular to and extends between uprights 12 in parallel with the plane of the uprights. Cross-brace 20 is connected to uprights 12 using any suitable means, such as welds, at a suitable location between the upper and lower portions of the uprights. Hanger 22 is perpendicular to and extends between the respective upper portions of uprights 12 in parallel with the plane of the uprights. Hanger 22 is connected to uprights 12 using any suitable means, such as welds. Alternatively, one or both of cross-brace 20 and hanger 22 may be integrally formed with uprights 12 as a single piece using any suitable method. Gussets 14 may be a single piece formed from any suitable material using any suitable method, such as bending, or may be multiple pieces connected using any suitable means, such as welds. Gussets 14 are each fixedly connected using any suitable means, such as welds, to a respective upright 12 adjacent the lower portion and cross-brace 20. Each gusset 14 extends orthogonally away from the plane of uprights 12 and opposite upper projections 16, forming a generally triangular shape with a respective upright. A pair of lower projections 18 are each connected to and extend from a respective gusset 14 in a direction orthogonally away from the plane of uprights 12, opposite the respective gusset, and in parallel with upper projections 16. Alternatively, lower projections 18 may each extend from the lower portion of a respective upright 12.

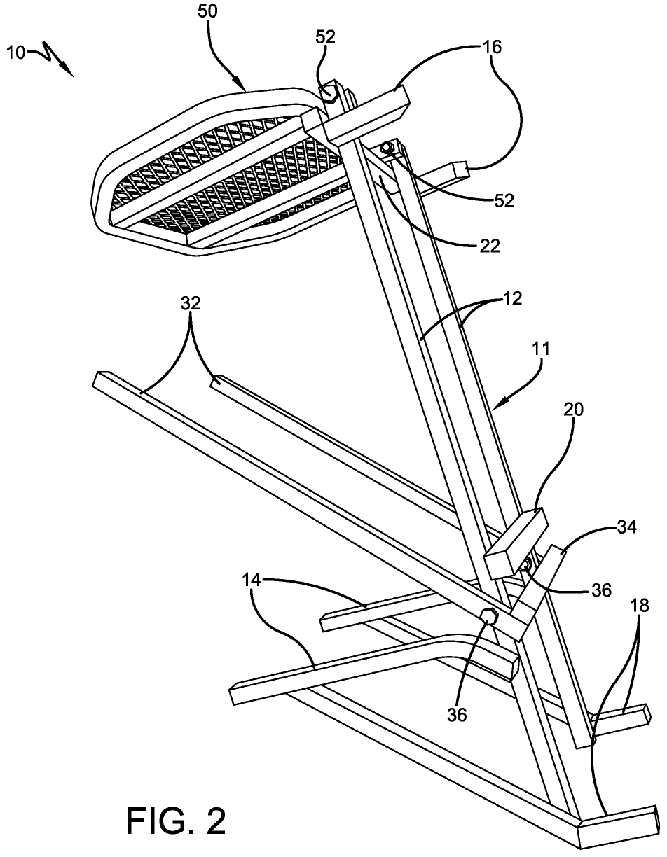

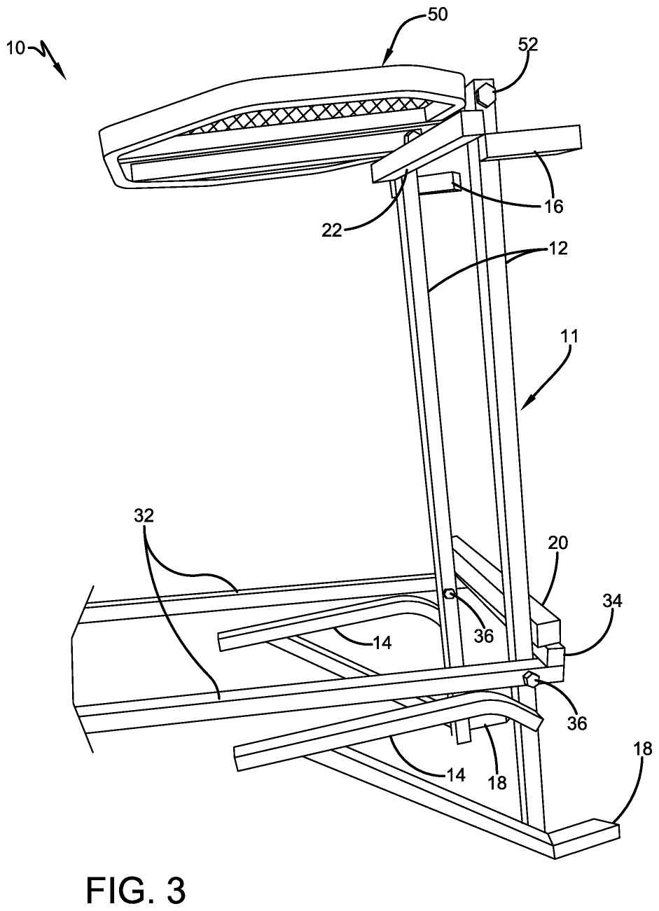

Tree stand 10 includes a platform assembly 30 formed from the same material as frame 11. Alternatively, platform assembly 30 may be formed from any other suitable material. Platform assembly 30 includes a pair of support arms 32, a positive stop 34, and a platform 40. Each of support arms 32 are pivotally attached to a respective upright 12 using a suitable fastener 36, such as a lag bolt. The pivotal connection provided by fastener 36 between support arms 32 and uprights 12 allow the support arms to rotate between an extended position (FIGS. 1 and 3), in which the support arms extend substantially orthogonally away from the plane of the uprights, and an upright position (FIG. 2), in which the support arms extend substantially vertically and substantially parallel to the uprights. The upright position of support arms 32 minimizes the profile or dimensions of tree stand 10, allowing the tree stand to be more easily carried and installed on the trunk of the tree. Support arms 32 are each attached adjacent a respective gusset 14, such that in the extended position each of the support arms are vertically coplanar and/or in contact with the respective gusset. As a result, once support arms 32 are pivoted into the extended position, gussets 14 provide additional support and bracing to the support arms. Platform assembly 30 includes positive stop 34 extending between and fixedly connected to respective ends of support arms 32 proximate uprights 12. In the extended position, support arms 32 are extended such that positive stop 34 contacts cross-brace 20 of frame 11, stopping the support arms from pivoting past horizontal, thereby countering forces acting on the support arms.

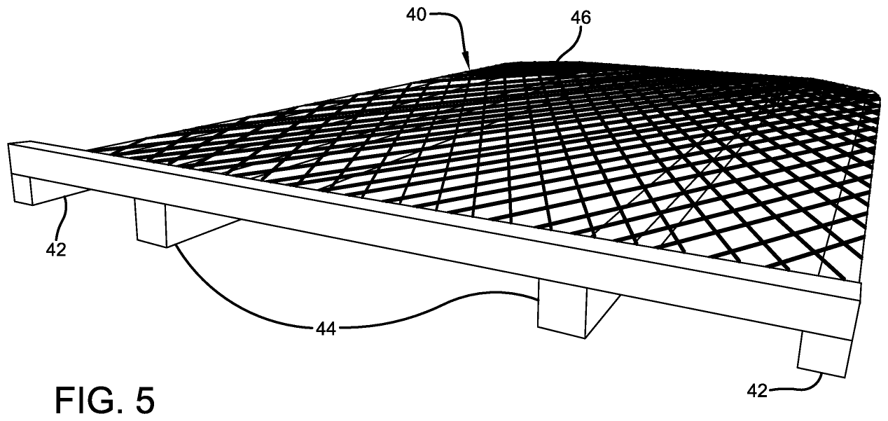

In accordance with an important aspect of the present invention, platform assembly 30 includes removable platform 40 (FIG. 5). Platform 40 is generally rectangular- or square-shaped and includes a pair of frame bodies 42 and a pair of beams 44 in a spaced-apart parallel arrangement. More specifically, beams 44 are spaced-apart, extend in parallel with, and are between frame bodies 42. A sheet 46 composed of chain-link, mesh, or other suitable material extends between frame bodies 42 over beams 44. Sheet 46 is fixedly connected to frame bodies 42 and beams 44 using any suitable means, such as welds. Beams 44 of platform 40 are removably connected to platform assembly 30. In particular, platform 40 is mounted on platform assembly 30 such that beams 44 are slidably disposed over and connected to support arms 32. More particularly, beams 44 have an internal dimension that is equivalent to or larger than an external dimension of support arms 32. An opening (not shown) is formed in each beam 44 perpendicular to the beam and uprights 12. Similarly, an opening (not shown) is formed in each platform support arm 32 perpendicular to the support arm and uprights 12. Once platform 40 is mounted on support arms 32, the openings in beams 44 and support arms 32 are aligned. A suitable fastener (not shown), such as a cotter pin or the like, is disposed through the aligned openings to removably secure platform 40 to platform assembly 30 and tree stand 10. Alternatively, platform 40 may be mounted such that beams 44 extend in parallel and are coplanar with and adjacent to support arms 32. Once platform 40 is mounted on support arms 32, the openings in beams 44 and support arms 32 are aligned and the fastener is disposed therethrough.

Tree stand 10 also includes a seat 50 formed from any suitable material or combination of materials, such as box section steel. Seat 50 is pivotally and removably connected to frame 11 adjacent to hanger 22. More specifically, seat 50 is connected to the top portion of each upright 12 by a fastener 52. Fastener 52 may be any suitable fastener, such as a bolt, that allows pivotal movement and facilitates disconnection of the fastener, and thus seat 50, from uprights 12. As a result, seat 50 is able to pivot between an extended position, in which the seat extends orthogonally away from the plane of uprights 12, and an upright position, in which the seat extends vertically and substantially parallel to the plane of the uprights. In the extended position, hanger 22 acts as a down stop for seat 50. More particularly, in the extended position, seat 50 contacts hanger 22, which prevents the seat from pivoting past horizontal.

During installation of tree stand 10, seat 50 and support arms 32 of platform assembly 30 are pivoted into respective upright positions to minimize the profile or dimensions of the tree stand, allowing the tree stand to be more easily carried to the tree onto which the tree stand is to be mounted. Alternatively, seat 50 may be detached from frame 11 by removing fasteners 52. Platform 40 may remain connected to platform assembly 30 and tree stand 10 or may be removed from the platform assembly to reduce the weight of the tree stand while being carried. Platform 40 is removed from platform assembly 30 prior to installation to reduce the weight of the tree stand during climbing. More specifically, the fasteners (not shown) through the aligned openings (not shown) in beams 44 and support arms 32 are removed, allowing platform 40 to be separated from platform assembly 30. Tree stand 10 is carried without platform 40 up the tree to the desired elevation and held in place while suitable mounting means (not shown), such as a strap or chains, are circumferentially arranged about the tree and frame 11 of the tree stand. The mounting means are circumferentially arranged about the tree and tree stand 10 such that the mounting means are adjacent hanger 22 of frame 11. The mounting means are then tightened about the tree and tree stand 10, as is known, to secure the tree stand to the tree at the desired height. Upper and lower projections 16, 18, respectively, contact and/or pierce the trunk of the tree when the mounting means are tightened, providing an offset or spacing between frame 11 and the tree and aiding in securing the tree stand to the tree. Once tree stand 10 is secured to the tree, seat 50 and support arms 32 are pivoted into the respective extended positions. The platform 40 is separately carried up the tree to tree stand 10 and placed on support arms 32. The fasteners are then placed through the aligned openings of support arms 32 and beams 44 to secure platform 40 to platform assembly 30 and tree stand 10.

Thus, tree stand 10, according to the present invention provides a light-weight tree stand that is relatively easier to carry and install in a tree. Platform 40 of tree stand 10 is free of cables, providing increased usable area on the platform; reducing or eliminating tripping, snagging, and entangling hazards; and reducing impediments to the user's line of sight, thereby improving the visual range of the user.

It is to be understood that tree stand 10 of the present invention may be formed from any suitable material or compound having sufficient rigidity and strength, such as aluminum, without changing the overall concept or operation of the present invention. It is also to be understood that components of tree stand 10 may be tubular or solid with any cross-sectional shape, such as polygonal, circular, elliptical, and the like, without changing the overall concept or operation of the present invention. It is still further to be understood that tree stand 10 may utilize fixed connections made using any suitable means, such as adhesives, mechanical fasteners, welds, and the like, without changing the overall concept or operation of the present invention. It is also to be understood that platform 40 of tree stand 10 may have any shape and/or size and may utilize any number of frame members 42 and/or beams 44 without changing the overall concept or operation of the present invention.

Accordingly, the hang-on tree stand, according to the present invention, is simplified; provides an effective, safe, inexpensive, and efficient structure and method, which achieve all the enumerated objectives; provides for eliminating difficulties encountered with prior hang-on tree stands; and solves problems and obtains new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed. Moreover, the subject disclosure has been described and illustrated with reference to specific aspects. It is understood that these descriptions and illustrations are by way of example and not by way of limitation. Potential modifications and alterations will occur to others upon a reading and understanding of the disclosure, and it is understood that the present invention includes all such modifications, alterations, and equivalents.

Having now described the features, discoveries, and principles of the invention; the manner in which the tree stand is used and installed; the characteristics of the construction, arrangement, and method steps; and the advantageous, new and useful results obtained, the new and useful structures, devices, elements, arrangements, process, parts, and combinations are set forth in the appended claims.

What is claimed is:

1. A hang-on tree stand comprising:
a frame; and
a platform assembly having a removably connected platform, said platform assembly being pivotally connected to and supported by said frame, the frame being free of cables.

2. The hang-on tree stand of claim 1, said frame further comprising a first cross-member contactable by said platform assembly.

3. The hang-on tree stand of claim 2, said platform assembly being capable of pivoting between a first position and a second position;
wherein a portion of said platform assembly contacts said first cross-member when the platform assembly is in said second position, the first cross-member acting as a positive stop for said platform assembly.

4. The hang-on tree stand of claim 3, said frame further comprising at least one gusset;
wherein said at least one gusset supports said platform assembly when said platform assembly is in said second position.

5. The hang-on tree stand of claim 4, wherein said platform assembly extends substantially parallel to said frame when the platform assembly is in said first position.

6. The hang-on tree stand of claim 1 further comprising a seat, said seat being pivotally and removably connected to said frame.

7. The hang-on tree stand of claim 6, said frame further comprising a second cross-member.

8. The hang-on tree stand of claim 7, said seat being pivotable between a first seat position and a second seat position;
wherein the seat contacts said second cross-member when said seat is in said second seat position.

9. The hang-on tree stand of claim 8, said seat being substantially parallel to said frame when the seat is in said first seat position.

10. The hang-on tree stand of claim 2, said frame further comprising at least one vertical upright, said first cross-member being connected to and extending perpendicular to said at least one vertical upright.

11. The hang-on tree stand of claim 10, said frame further comprising at least one gusset connected to and extending orthogonally away from said at least one vertical upright and said first cross-member.

12. The hang-on tree stand of claim 11, said frame being formed as a single component.

13. The hang-on tree stand of claim 11, said at least one vertical upright, said first cross-member, and said at least one gusset being formed from box section steel.

14. The hang-on tree stand of claim 10, said platform assembly further comprising at least one support arm;
wherein said at least one support arm pivotally connects said platform assembly to said vertical upright of said frame.

15. The hang-on tree stand of claim 14, said platform further comprising at least one beam
wherein said beam removably connects the platform to said support arm of said platform assembly.

16. The hang-on tree stand of claim 1, said frame being secured to a tree by at least one of a wrap or chain.

17. The hang-on tree stand of claim 16, said frame further comprising at least one projection, said projection extending orthogonally away from the frame and into said tree.

18. The hang-on tree stand of claim 16, said frame further comprising a cross-member;
wherein said at least one of said wrap or chain being disposed circumferentially about the frame adjacent said cross-member, the cross-member supporting said frame on the at least one of said wrap or chain.
